(19) United States
(12) Patent Application Publication
(10) Pub. No.: US 2021/0074236 A1
(43) Pub. Date: Mar. 11, 2021

(54) GENERATING A DISTINCT IMAGE THAT'S VISUALLY IDENTIFIABLE

(71) Applicant: CHENGZHI YANG, MENLO PARK (UA)

(72) Inventor: CHENGZHI YANG, MENLO PARK (UA)

(21) Appl. No.: 16/875,944

(22) Filed: May 15, 2020

Related U.S. Application Data
(63) Continuation of application No. 15/097,484, filed on Apr. 13, 2016, now abandoned.

(51) Int. Cl. G09G 5/00; G06T 11/20; G09G 5/36; G09G 5/14; G06T 11/00; G06Q 10/10; G06Q 50/00

(52) U.S. Cl. CPC G09G 5/003; G06T 11/20; G09G 5/363; G09G 5/14; G06T 11/001; G09G 2370/16; G06Q 10/10; G06Q 10/101; G06Q 50/01; G09G 2370/022; G06Q 10/1095

(57) ABSTRACT

A method and system generates an image on multiple devices associated with a transaction or meeting request. Two or more users who are party to the same electronically arranged transaction will have the same distinct image displayed on their electronic devices to enable identification visually. Users can identify one another when each's device is help up in plain view, respective parties may look for a display output on another's device that matches the image generated on their own device.

### CROSS-REFERENCE TO RELATED APPLICATION

This is a continuation application that claims priority to U.S. patent application Ser. No. 15/097,484 (Attorney Docket No. 29101.2), filed Apr. 13, 2016, and entitled SYSTEM AND METHODS FOR ELECTRONIC DISPLAY IMAGE MATCHING AND RECOGNITION OF PARTIES; which is incorporated herein in its entirety by reference.

### BACKGROUND

The embodiments herein relate generally to software products, systems, and methods to generate distinct electronic displays and images to facilitate the visual matching and recognition of parties involved in electronically arranged transactions.

It is commonly difficult to identify people whom you have never met in a crowd, or from a distance in a moving vehicle, for the purpose of completing a transaction arranged online, such as by using mobile devices. For example, a software user may order a delivery service, or request a car ride, or arranged for other hired services. The requesting party and the service provider, having never met may spend a lot of time trying to identify each other using small profile pictures. Often, people look different from their pictures or more than one person shares the description at a location. For example, a driver trying to pick up a passenger at an airport may be forced to loop around if he cannot quickly and positively identify his intended passenger. In other situations, for example, in delivery services, a way does not currently exist for both the customer and the service provider to quickly and positively identify each other without divulging private information such as name or phone number or the contents of the order.

As can be seen, there is a need to improve the process of effectively and quickly identifying parties who had not met face-to-face before.

### SUMMARY

In one aspect, a computer program product for providing visual or recognition to matched parties via generated images on a plurality electronic displays comprises a non-transitory computer readable storage medium having computer readable program code. The computer readable program code is configured to: generate an image which may consist of multiple frames of differing background color, and within each frame, patterns or easily recognizable symbols. The program is capable of generating up to 4 billion distinct images using a random combination of different colors, patterns, common symbols, letters and characters, and/or frame placement options. The same generated image will be displayed on the electronic devices of participating parties for a given transaction so the parties can identify each other quickly.

In another aspect, a method to generate an identical image based on either a text or binary string so images displayed on electronic devices that are party to the same transaction will be visually identifiable to the users. This method, as implemented by a software module that is installed on the respective electronic devices, when given the same input string, will generate the same graphic. Each digit will instruct the module to use a specific choice of colors, patterns, common symbols, letters and characters, and/or frame placement option. So electronic devices provided with the same string, such as a transaction ID, will have a same graphic displayed. To generate distinct graphics, the methods select from a pre-designated choice of different colors, patterns, common symbols, letters and characters, and/or frame placement options.

### BRIEF DESCRIPTION OF THE FIGURES

The detailed description of some embodiments of the invention is made below with reference to the accompanying figures, wherein like numerals represent corresponding parts of the figures.

FIGS. 1A-1B is a flowchart of a method for providing recognition of matched parties via generated images on an electronic display in accordance with an embodiment of the subject technology.

FIG. 2 is a block diagram of a computer system according to an embodiment of the subject technology.

FIGS. 3A-3C are a scenes of diagrams showing a process of recognition between parties in a system generating matching electronic displays according to embodiments of the subject technology.

FIGS. 4-6 are front views of electronic displays showing various display configurations according to embodiments of the subject technology.

### DETAILED DESCRIPTION OF CERTAIN EMBODIMENTS

Broadly, embodiments of the subject technology provide a system and method of generating matching display outputs on multiple electronic devices so that parties trying to locate each other, may identify one another as being part of a transaction or meeting by matching display outputs that are associated with the transaction or meeting.

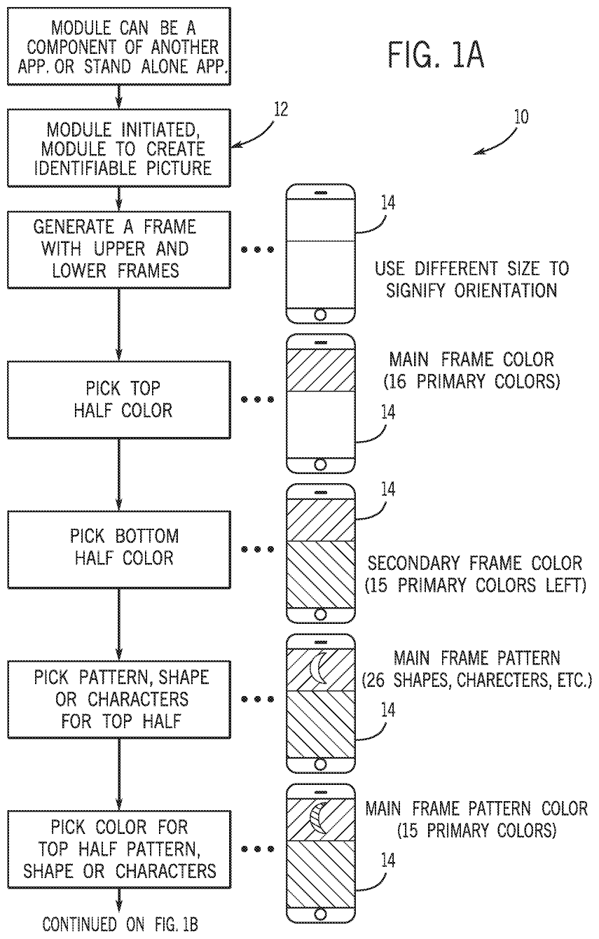

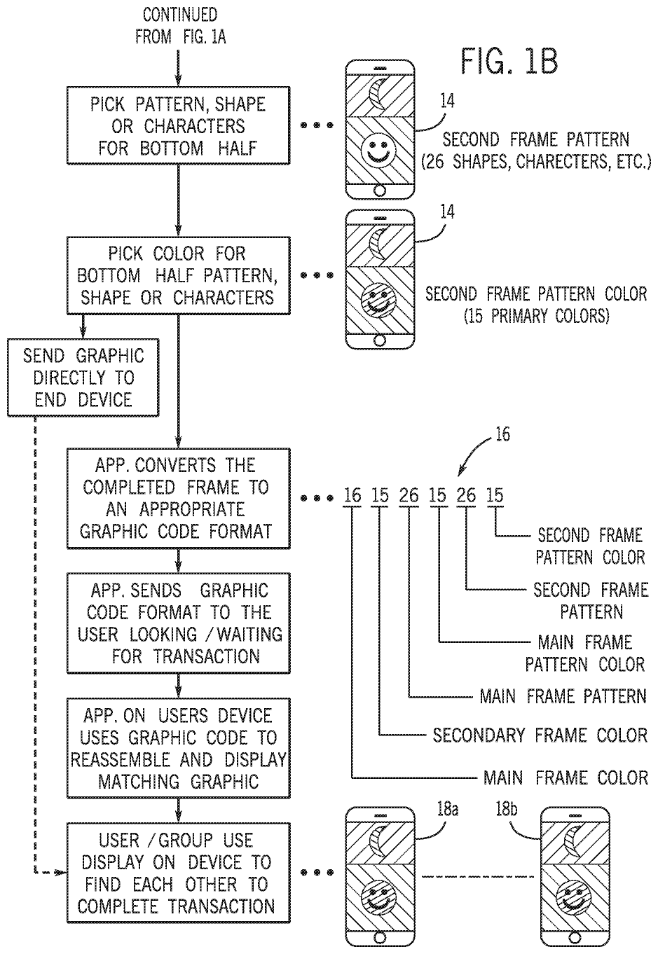

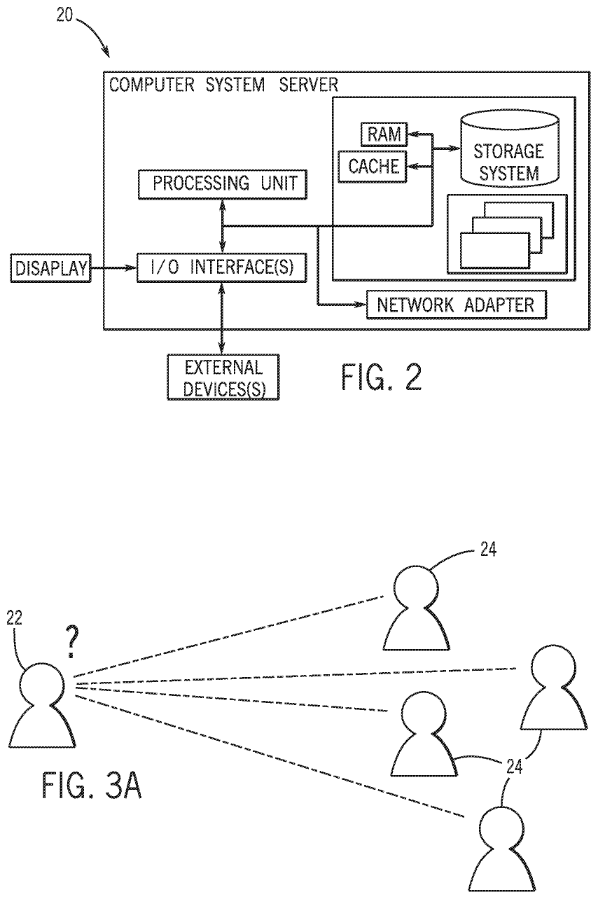

Referring to FIGS. 1A-1B, a method 100 for providing recognition of matched parties via generated images on an electronic display is shown according to an exemplary embodiment. The flowchart of method 100 includes on the right hand side depictions of a general computing device 200 (referred to in general as the “device 200”) (shown in the exemplary form of a mobile phone) with an electronic display 205 whose output is modified via steps in the method 100. Additional elements aside from the display 205 and functions of the device 200 are described more fully below. For example, unless indicated otherwise, the steps may be performed by a processor 280 (FIG. 2).

In block 110, a software based module may be initiated to create an image as a display output associated with a transaction or meeting request. Generally, the module may be a software app loaded onto a mobile device 200 that a user starts to create a display output that will be matched to another user's device 200. The method 100 generates an object and/or pattern on multiple frames of the display output that can be recognized by multiple parties trying to identify, for example, a previously unknown other party. The user and the other user may be for example, two parties that are unknown to one another and engaging in some form of meeting. An exemplary application of the subject technology may be used for example, when a user hires a car service. The driver and user may benefit from the subject technology by generating easily recognizable display outputs (an identifiable picture) on each other's respective device 200 so that if held up in plain view, the user or the driver may scan for a display output matching the display output on his or hers respective device 200. Other applications which may benefit from the subject technology include dating apps and delivery apps (such as food or medication delivery) which provide both sides to locate or verify the other party is who they claim to be. In some embodiments, the display output may be generated at a central server and simultaneously transmitted to both devices 200. In some embodiments, the display output may be generated on one device 200 and then may be transmitted to a targeted device 200.

In block 115, a primary frame 210 and a secondary frame 250 may be generated on the display 205. In an exemplary embodiment, one frame may be on an upper section of the display while the other frame may be on a lower section or vice versa. In some embodiments, the primary frame 210 occupies a larger or smaller area of the display 205 than the secondary frame 250. In block 120, a color 215 for the primary frame 210 may be generated. In block 125, a color 255 for the secondary frame 250 may be generated. In block 130, an object (for example, a shape or character) and/or pattern 220 may be generated for the primary frame 210. In block 135, a color 225 for the pattern and/or object 220 may be generated. In block 140, an object (for example, a shape or character) and/or pattern 260 may be generated for the secondary frame 250. In block 145, a color 265 for the pattern and/or object 260 may be generated. In some embodiments, as described in bloc 150, the primary frame 210 and secondary frame 250 and each's respective display content may be converted into a coded string 270 (for example, a graphic code format) representing elements in the primary frame 210 and the secondary frame 250. The coded string 270 may include string values 275 representing for example, the color 215, the color 255, the object and/or pattern 220, the object and/or pattern color 225, the object and/or pattern 260, and the object and/or pattern color 265. Each number in the coded string 270 represents an exemplary maximum number of options for each value however it will be understood that a different maximum value may be used in practice. In some embodiments, the coded string 270 may include a value for a visual effect such as pulsating or flashing to a rhythm which will enhance visual identification. In block 155, the coded string 270 may be transmitted to the user'(s) device 200. In block 160, the coded string 270 may be read and the display output may be assembled according to the values 275. In block 165, the user(s) may show the matching display outputs on respective device 200A and 200B (for example, by holding the devices 200A and 200B in front of them) so that each can recognize the display output on the other's device 200 and identify each other as the party being sought.

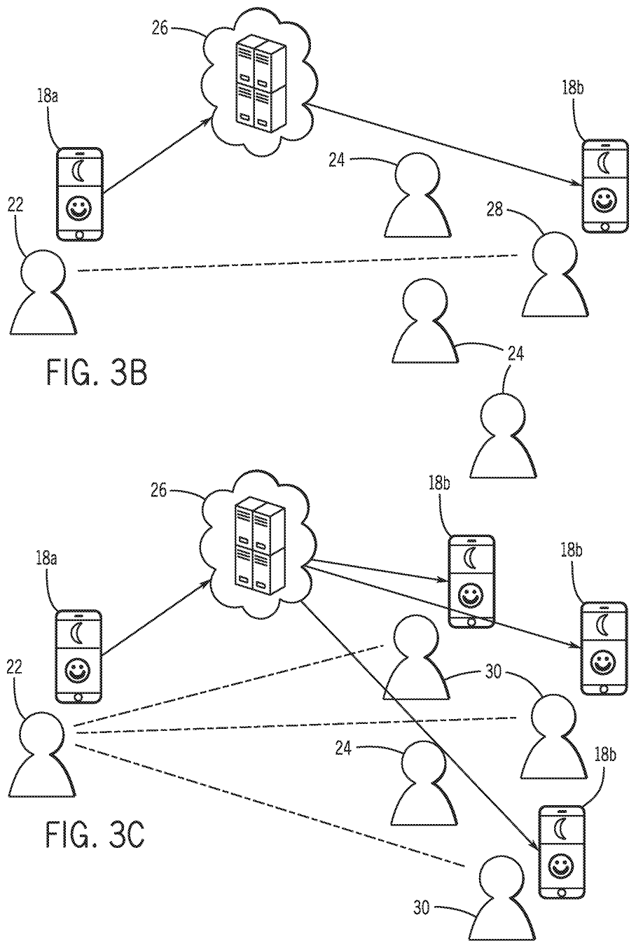

Referring now to FIG. 2, a schematic of an example of the general computing device 200 is shown. The components of the device 200 may include, but are not limited to, one or more processors or processing units 280, an electronic display 205, a system memory 295, and a bus 282 that couples various system components including the system memory 295 to the processor 280. The device 200 may be for example, mobile telephone devices, tablet devices, handheld or laptop devices, programmable consumer electronics, or wearable computing devices (for example, smart watches) when serving the role as the device showing a generated display output as described for example, above. In some embodiments, the device 200 may be a general purpose computing device hosting a central point of the system between two users (for example, as a host server 400 as shown in FIGS. 3B-3C) in which case the device 200 may be personal computer systems, multiprocessor systems, server computer systems, microprocessor-based systems, set top boxes, network PCs, and distributed cloud computing environments that include any of the above systems or devices, and the like. The device 200 may be described in the general context of computer system executable instructions, such as program modules 292, being executed by a computer system (described for example, below). The device 200 may be practiced in distributed cloud computing environments where tasks are performed by remote processing devices that are linked through a communications network. In a distributed cloud computing environment, program modules may be located in both local and remote computer system storage media including memory storage devices.

The device 200 may typically include a variety of computer system readable media. Such media could be chosen from any available media that is accessible by the device 200, including non-transitory, volatile and non-volatile media, removable and non-removable media. The system memory 295 could include one or more computer system readable media in the form of volatile memory, such as a random access memory (RAM) 296 and/or a cache memory 298. By way of example only, a storage system 294 can be provided for reading from and writing to a non-removable, non-volatile magnetic media device. The system memory 295 may include at least one program product 290 having a set of program modules 292 that are configured to carry out the functions of embodiments of the invention. The program modules 292 generally carry out the functions and/or methodologies of embodiments of the invention as described herein.

The device 200 may also communicate with one or more external devices 286 such as a keyboard, a pointing device, etc.; and/or any devices (e.g., network card, modem, etc.) that enable the device 200 to communicate with one or more other computing devices. Such communication can occur via Input/Output (I/O) interfaces 284. Alternatively, the device 200 can communicate with one or more networks such as a local area network (LAN), a general wide area network (WAN), and/or a public network (e.g., the Internet) via a network adapter 288.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro- code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon. It will be understood that each block of the block diagrams, and combinations of blocks in the flowchart illustrations and/or block diagrams, can be implemented as instructions provided to the processor 280 of a general purpose computer, special purpose computer, or other programmable data processing apparatus to produce a machine, such that the instructions, which execute via the processor 280 of the computer or other programmable data processing apparatus, create means for implementing the functions/acts specified in the flowchart and/or block diagram block or blocks.

Any combination of one or more computer readable media may be utilized. In the context of this disclosure, a computer readable storage medium may be any tangible or non-transitory medium that can contain, or store a program for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Referring now to FIGS. 3A-3C, diagrams depict exemplary scenarios related to the embodiments described above. In FIG. 3A, a first user 310 with device 200A wishes to meet with one or more users 320 (user 320A, and/or user 320B, and/or user 320C, and/or user 320D) under some predetermined electronic meeting request or transaction (for example, a sales transaction or a group meeting). To identify and locate the appropriate user(s) 320, user 310 may send a request to server 400 through device 200A to identify users 320 associated with the predetermined meeting request. The server 400 may transmit the request to all eligible users 320. Matching display outputs (as described above) are generated for each side of the meeting request on devices 200A and 200B. As shown in FIG. 3B, some embodiments may be a one-to-one meeting request and a matching display output is shown for user 310 and user 320B. In FIG. 3C, an embodiment is shown for a group meeting request in which users 320A, 320B, and 320C with respective devices 200B1, 200B2, and 200B3 show display outputs matching the display output of device 200A and are thus identifiable as belong to group 350. User 320C does not receive the matching display output and is thus not part of group 350.

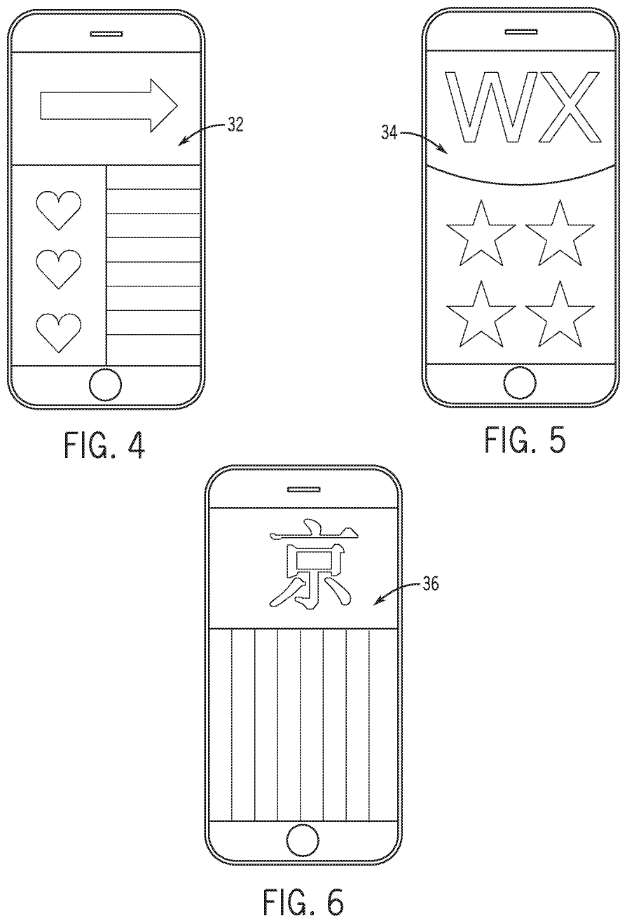

Persons of ordinary skill in the art may appreciate that numerous design configurations may be possible to enjoy the functional benefits of the inventive systems. For example, while the foregoing was described in the context of the primary frame 210 and secondary frame 250 occupying a display divided by a horizontal line demarcating a top portion being smaller than a bottom portion and arbitrary shapes and diagonal hatching patterns, other configurations may be used. Referring now to FIGS. 4-6, additional exemplary embodiments of the generated display out for a device 200 are shown. The generated display output may use a third frame 230 in addition to the frames 210 and 250 as shown in FIG. 4. Moreover, the frames 230 and 250 may be divided by a vertical line instead of a horizontal line. In another embodiment, a curved line 240 (FIG. 5) may divide the frames 210 and 250. Referring to FIG. 6, in another exemplary embodiment, a foreign character 245 may be used instead of an object or shape. Thus, given the wide variety of configurations and arrangements of embodiments of the present invention the scope of the invention is reflected by the breadth of the claims below rather than narrowed by the embodiments described above.

What is claimed is:

1. A computer program product for providing graphic visual recognition of matched parties via generated images on a plurality electronic displays, the computer program product comprising a non-transitory computer readable storage medium having computer readable program code embodied therewith, the computer readable program code being configured to:
generate a primary frame for a first section of a first electronic display of a first electronic device and a secondary frame for a second section of the first electronic display, wherein the primary and secondary frames are divided by a horizontal line and together fill the first electronic display of the first electronic device;
generate a first object and/or first pattern for the primary frame;
generate a second object and/or second pattern for the secondary frame;
display on the first electronic display the first object and/or first pattern in the primary frame and the second object and/or second pattern in the secondary frame;
display on a second electronic display of a second electronic device, the first object and/or first pattern in the primary frame on a first section of the second electronic display and the second object and/or second pattern in the secondary frame on a second section of the second electronic display for recognition of the first electronic device by a user of the second electronic device; and
send from a central server a coded string comprising a graphic code format representing elements in the primary frame and the secondary frame to each of the first electronic device and the second electronic device for generation of the primary frame and secondary frame on respective first and second electronic displays.
